(19) United States
(12) Patent Application Publication
(10) Pub. No.: US 2018/0306336 A1
(43) Pub. Date: Oct. 25, 2018

(54) CHECK VALVE

(71) Applicant: CRANE ChemPharma & Energy Flow Solutions, Kreutzal (DE)

(72) Inventors: Simon LUSTY, Kreutzal (DE); Stephen HANNA, Kreutzal (DE); Ranjit BHALKAR, Kreutzal (DE)

(21) Appl. No.: 15/958,125

(22) Filed: Apr. 20, 2018

(30) Foreign Application Priority Data
Apr. 21, 2017 (GB) 1706359.5

(51) Int. Cl. F16K 15/03

(52) U.S. Cl. CPC F16K 15/038; F16K 15/033

(57) ABSTRACT

A check valve comprising a valve body having a central bore a hinge pin a blocking means pivotably attached to the hinge pin and moveable between a first position in which the blocking means blocks the central bore and a second position in which the blocking means does not block the central bore, and a biasing means arranged to bias the blocking means into the first position, wherein the valve body comprises at least one boss projecting from an inner wall of the valve body into the central bore, and wherein said boss provides an anchoring point at which the hinge pin is secured to the valve body.

### CROSS-REFERENCE TO RELATED APPLICATIONS

This application claims priority to GB Application No. 1706359.5 filed on Apr. 21, 2017, which is incorporated by reference herein in its entirety.

### TECHNICAL FIELD

This invention relates to a check valve, a method of manufacturing a check valve, and a kit of parts for assembly into a check valve.

### BACKGROUND

Check valves are self-acting non-return valves, designed to allow fluid flow in one direction only, protecting fluid pumping source equipment. A well-known type of check valve is a dual plate check valve. These generally comprise a circular pressure-containing housing with two semi-circular or “D” shaped plates that pivot about a hinge pin along the central axis of the housing.

In the installed condition, when the pumping source is activated, the plates will open allowing fluid to flow through the valve. When the pumping source is stopped, the fluid in the pipeline will slow down in the forward direction. When the flow reduces sufficiently, the spring will begin to close the plates. Any reverse flow generated, and the spring force, will close the plates against the valve body housing and central rib, minimising the magnitude of the reverse flow velocity and thus protecting the pump source equipment from damage.

Dual plate check valves were first developed in the 1950s. The first designs involved drilling through-holes in the valve body to locate two sealing plates that close against the valve body internal diameter and along the central rib. The holes drilled in the body were sealed by NPT (National Pipe Taper) threaded “retainers” to prevent emissions to atmosphere.

The second design iteration (hereafter referred to as “second generation” dual plate check valves) eliminated the cross-drilling of the valve body, and included a design feature to allow retention of the sealing plates. The sealing plates in the design are held in place by inserts fitted into the internal body and held in place by an expanding snap ring. The removal of the cross drilling removed the possibility of leakage to atmosphere by fugitive emissions through the retainers and so this design is hence referred to as a “retainerless” design.

An example of a second generation dual plate check valve is shown in FIG. 1 in exploded view. A valve body 1 contains a pair of semi-circular plates 2a, 2b arranged on bearings 3. The bearings 3 are held in place by a pair of inserts 4a, 4b, which are in turn held in place by an expanding snap ring 5. The plates 2a, 2b are biased into their closed position by a spring 6. In use, fluid flow in a forward direction overcomes the force provided by the spring 6, moving the plates 2a, 2b into their open position to permit fluid to pass through the valve body 1.

Alternative methods of holding the inserts in place include locking plates, clips and fixing screws.

The use of inserts and associated fixing means is undesirable, as these components contribute to the cost of the check valve. Additionally, the use of inserts adds to the complexity of the check valve, which in turn results in a check valve which is difficult to assemble, and upon which it is difficult to perform maintenance.

The present invention aims to overcome some of the drawbacks associated with prior art check valves. It achieves this by using a portion of the valve body itself to provide an anchoring point to locate the bearings and semi-circular plates.

This construction reduces machining elements. By using forging, or an investment casting instead of a sand casting, the machining allowances are reduced. This reduces the amount of material which needs to be removed during manufacture, which also cuts down on machining time.

Prior art check valves (such as that shown in FIG. 1) also require two machine setup operations: one to machine the bore and one to drill the semicircular recesses for the inserts along the length of the bore. With the present invention, all surfaces (bosses, pin slots, access slots and seal surfaces, as will be described below) can be milled in one machine setup.

This construction also eliminates expensive engineered components, such as the snap ring 5 and inserts 4a, 4b shown in FIG. 1. Each of these are bespoke components. In the present invention these parts have been replaced with off the shelf short pins and grub screws, which reduces cost and improves ease of assembly and maintenance.

### SUMMARY OF THE INVENTION

In accordance with a first aspect of the present invention there is provided a check valve comprising:
a valve body having a central bore;
a hinge pin;
a blocking means pivotably attached to the hinge pin and moveable between a first position in which the blocking means blocks the central bore and a second position in which the blocking means does not block the central bore; and
a biasing means arranged to bias the blocking means into the first position,
wherein the valve body comprises at least one boss projecting from an inner wall of the valve body into the central bore,
and wherein said boss provides an anchoring point at which the hinge pin is secured to the valve body.

In accordance with a second aspect of the present invention there is provided a method of assembling a check valve, the method comprising the steps of:
providing a valve body having a central bore, wherein the valve body comprises at least one boss projecting from an inner wall of the valve body into the central bore, said boss comprising an anchoring point;
providing a sub-assembly comprising a hinge pin, a blocking means pivotably attached to the hinge pin and moveable between a first position and a second position, and a biasing means arranged to bias the blocking means into the first position;
inserting the sub-assembly into the valve body;
rotating the sub-assembly until the hinge pin contacts the anchoring point; and
securing the hinge pin to the anchoring point,
wherein, following insertion of the sub-assembly into the valve body, the blocking means blocks the central bore in its first position and does not block the central bore in its second position

In accordance with a third aspect of the present invention there is provided a kit of parts for assembly into a check valve, the kit of parts comprising:
a valve body having a central bore, wherein the valve body comprises at least one boss projecting from an inner wall of the valve body into the central bore,
said boss comprising an anchoring point;
a sub-assembly for insertion into the valve body, the sub-assembly comprising:
   a hinge pin;
   a blocking means pivotably attached to the hinge pin and moveable between a first position and a second position; and
   a biasing means arranged to bias the blocking means into the first position, wherein, following insertion of the sub-assembly into the valve body, the blocking means blocks the central bore in its first position and does not block the central bore in its second position; and
   means to secure the hinge pin to the valve body at the anchoring point.

In each of the above, the valve body could comprise a pair of bosses located at diametrically opposed positions on the inner wall of the valve body, each boss providing anchoring points at which a respective end of the hinge pin is secured to the valve body.

In each of the above, the valve body could comprise a horizontal slot extending along the central bore, along which the hinge pin may be inserted into the valve body.

In each of the above, the, or each, anchoring point could comprise a through-hole extending through the, or each, boss, through which a retaining means may be passed to secure the hinge pin to the valve body. Said retaining means could comprise a locking pin.

In each of the above, the blocking means could comprise a pair of semi-circular plate members attached to the hinge pin. A stop pin could be positioned within the central bore to prevent the pair of semi-circular plate members from contacting one another. Said stop pin could be secured to the valve body at the, or each, anchoring point.

In each of the above, the biasing means could comprise a coil spring.

### BRIEF DESCRIPTION OF THE DRAWINGS

The invention will now be described with reference to the accompanying drawings, in which:

FIG. 1 shows a dual plate check valve;

FIG. 2 shows a cross-sectional view of a valve body suitable for use in the present invention;

FIG. 3 shows a perspective view of the valve body of FIG. 2;

FIGS. 4-7 schematically show perspective views of an apparatus in accordance with an embodiment of the present invention at various stages of assembly; and

FIGS. 8a, 8b and 8c respectively show perspective, cross-sectional and cutaway views of the apparatus of FIGS. 4-7 fully assembled.

### DETAILED DESCRIPTION

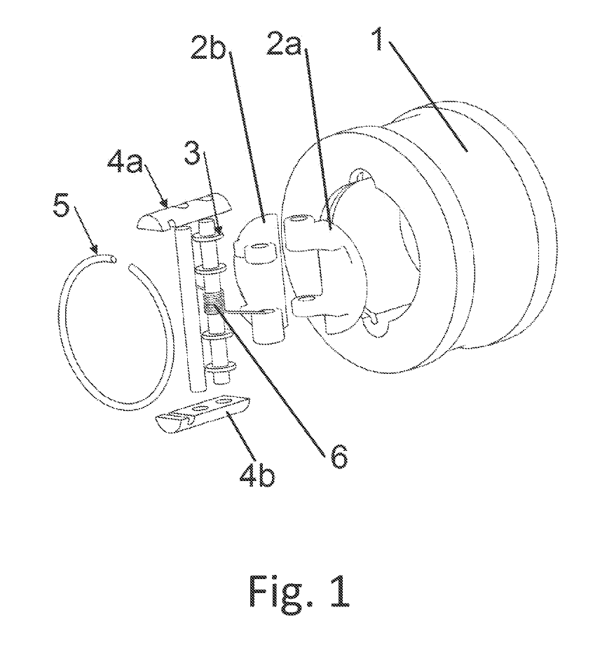

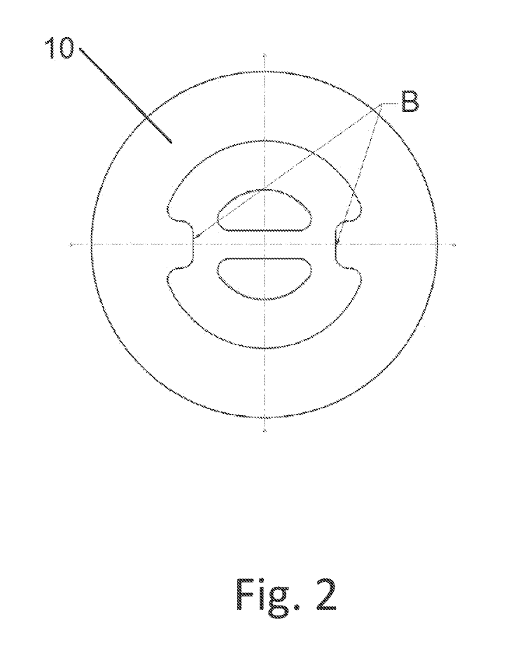

FIG. 2 shows a cross-sectional view of a valve body 10 suitable for use in the present invention. The valve body 10 has an internal bore through which fluid may flow when the valve body 10 is connected to a pipeline. In the prior art, the internal bores of valve bodies are generally circular, and may include cutaways for receiving inserts (see, for example, the valve body shown in FIG. 1). However, in the present invention, the internal bore of the valve body 10 includes a pair of diametrically opposed bosses B which project into the internal bore.

Compared to prior art check valves, the diameter of the internal bore has been increased to allow room for the bosses B on the walls of the valve body 10. The bosses B are integrally formed with the valve body 10.

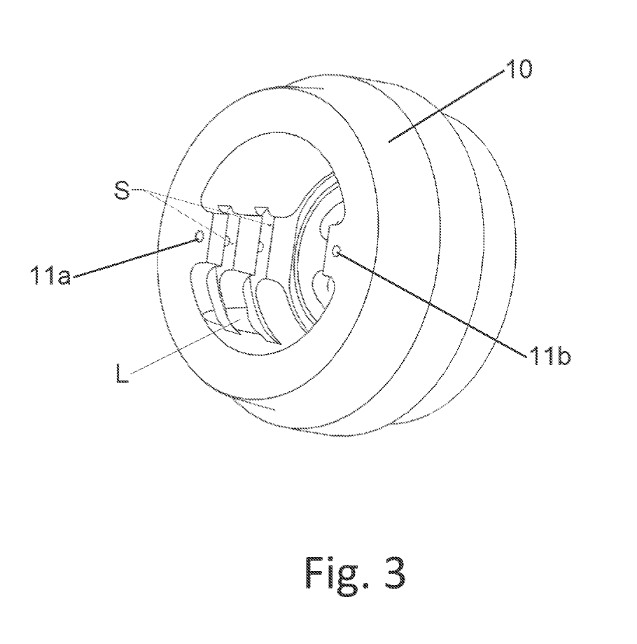

As can be seen in FIG. 3, the bosses B have a pair of vertical slots S cut into them, spaced along the valve body 10. The bosses B also have a horizontal slot L cut into them, which extends along the valve body 10 as shown. Only one horizontal slot L can be seen in FIG. 3, however the boss on the opposite side has an equivalent horizontal slot, diametrically opposed to the horizontal slot L visible in FIG. 3. Both slots are formed by milling during the manufacturing process. The bosses B have respective through-holes 11a and 11b drilled into them.

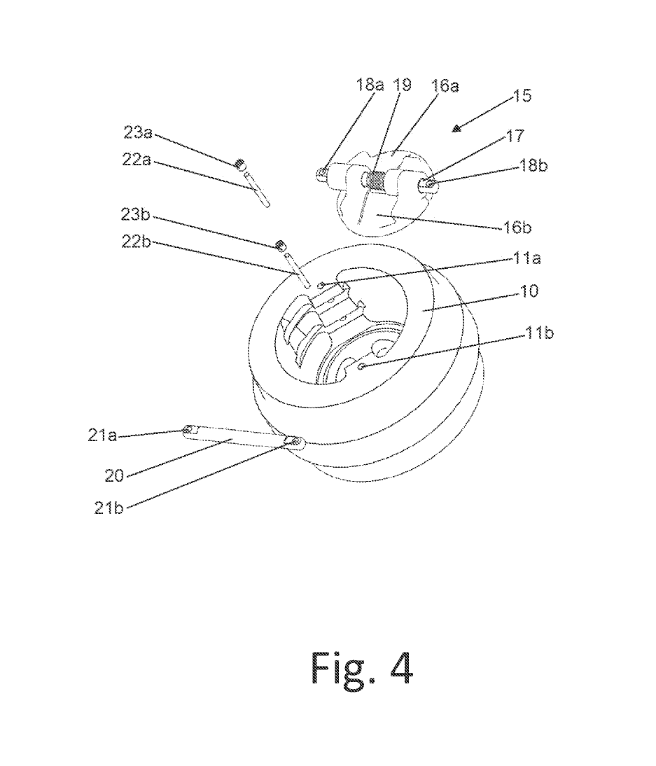

FIG. 4 schematically shows a perspective view of an apparatus in accordance with an embodiment of the present invention prior to assembly. The valve body 10 is the same as that shown in FIG. 3.

The apparatus comprises a hinge pin and plate sub-assembly 15. The assembly 15 comprises a pair of semi-circular plates 16a, 16b arranged for pivoting movement about a hinge pin 17. The hinge pin 17 has a first aperture 18a at a first end, and a second aperture 18b at a second end. A coil spring 19 surrounds the hinge pin 17 and acts to bias the semi-circular plates 16a, 16b into their respective closed positions.

The apparatus further comprises stop pin 20. Similarly to the hinge pin 17, the stop pin 20 has a first aperture 21a at a first end, and a second aperture 21b at a second end.

Finally, the apparatus further comprises a pair of locking pins 22a, 22b and a pair of associated grub screws 23a, 23b.

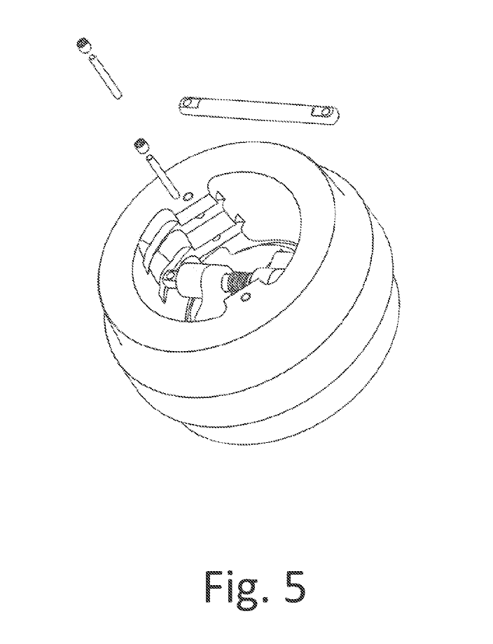

FIG. 5 schematically shows a perspective view of the apparatus of FIG. 4 at a first stage of assembly.

The sub-assembly 15 has been inserted into the interior of the valve body 10. This is achieved by aligning the hinge pin 17 with the horizontal slots L. These slots provide enough clearance for the hinge pin 17 to be inserted perpendicular to the inner wall of the valve body 10. The diameter of the interior bore of the valve body is less than the length of hinge pin 17 at every other point on the inner wall, and so the sub-assembly can only be inserted at a predetermined angle (although it may also be inserted 180° to this angle).

The sub-assembly 15 is progressively inserted in the valve body 10 until the hinge pin 17 contacts a portion of the inner wall of the valve body 10 at the point shown in FIG. 5. At this point, the hinge pin has reached the end of horizontal slot L, and abuts a portion of the inner wall of the valve body 10, preventing further insertion. This aids assembly of the dual check valve, as an installer need not check to see how far the sub-assembly 15 has been inserted into the valve body 10. Instead, an installer can simply insert the sub-assembly 15 to its furthest extent, at which point he will know that the hinge pin 17 is aligned with the appropriate slot of the bosses B.

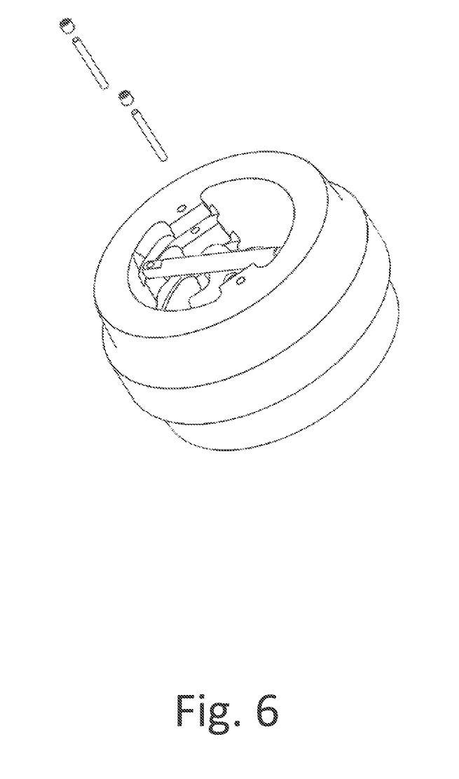

FIG. 6 schematically shows a perspective view of the apparatus of FIG. 4 at a further stage of assembly.

In FIG. 6, the sub-assembly 15 has been rotated in a clockwise direction relative to the direction of insertion until the first and second apertures 18a, 18b of the hinge pin 17 are aligned with the through-holes 11a, 11b. The stop pin 20 has been inserted into the valve body 10 in a similar way to the hinge pin 17 until it is aligned with an appropriate slot of the bosses B.

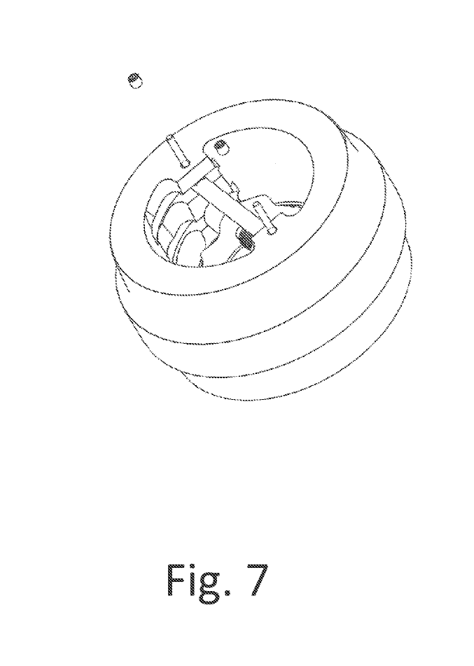

FIG. 7 schematically shows a perspective view of the apparatus of FIG. 4 at a yet further stage of assembly.

The stop pin 20 has been rotated in a clockwise direction relative to the direction of insertion until its first and second apertures 21a, 21b are aligned with the through-holes 11a, 11b.

The locking pins 22a, 22b are shown being inserted into through-holes 11a, 11b.

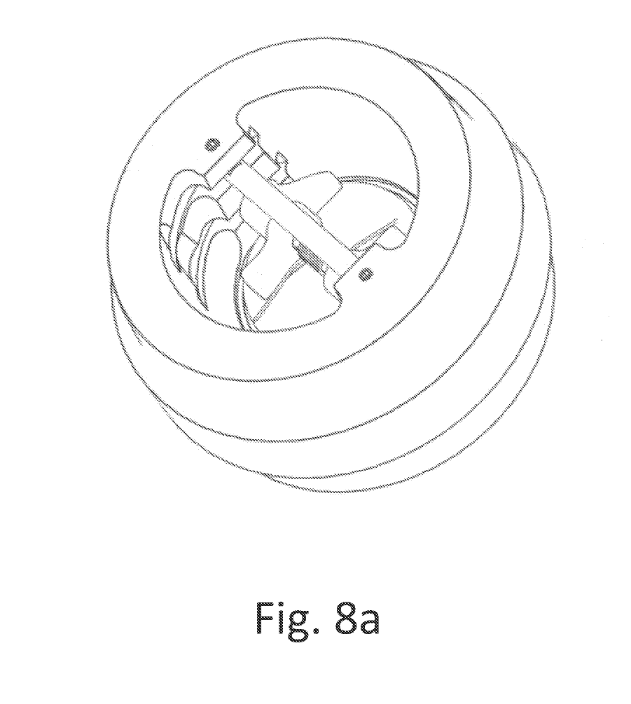

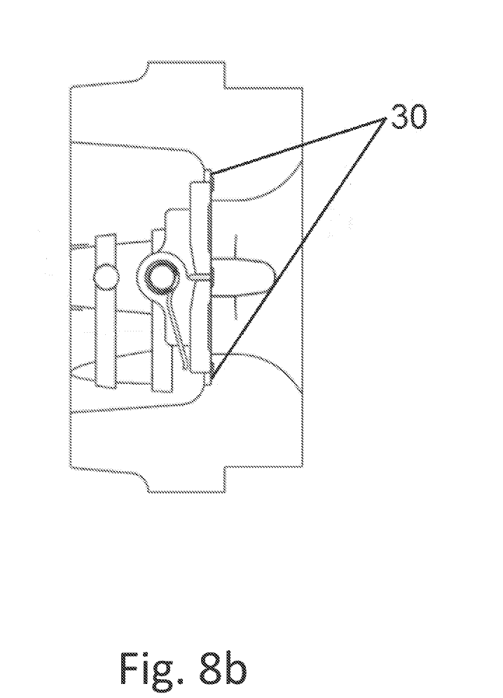

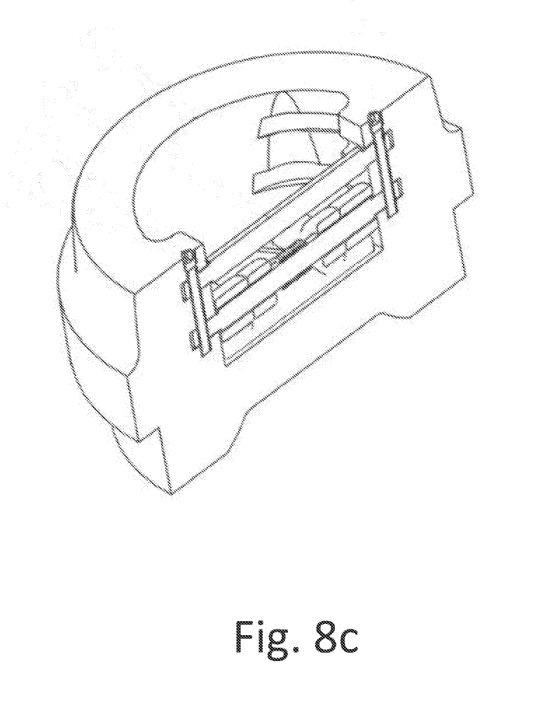

FIG. 8a shows a perspective view of the apparatus of FIG. 4 fully assembled. The locking pins 22a, 22b have been fully inserted into through-holes 11a, 11b, and the grub screws 23a, 23b have been inserted into through-holes 11a, 11b, and rotated to hold the locking pins 22a, 22b in place. In this fully assembled state, the locking pins 22a, 22b pass through the through-holes 11a, 11b, the first and second apertures 21a, 21b of the stop pin 20 and the first and second apertures 18a, 18b of the hinge pin 17. The locking pins 22a, 22b act to hold the stop pin 20 and the hinge pin 17 in their respective positions and prevent their movement.

The semi-circular plates 16a, 16b may rotate around the hinge pin 17 when the force provided by fluid flow in the valve body exceeds the combined force provided by the spring 19 and the pressure differential across the semi-circular plates 16a, 16b. The extent of the rotation of the semi-circular plates 16a, 16b is limited by the stop pin 20, which prevents the semi-circular plates 16a, 16b from fluttering due to vortex shedding. This acts to reduce wear and pressure loss.

FIG. 8b shows a cross-sectional view of the apparatus of FIG. 4 fully assembled.

In this view it is possible to see a runout groove 30. This is provided where both the semi-circular plates 16a, 16b and the valve body 10 form a metal to metal seal, to prevent a raised edge forming on the body seal surface during lapping, which could hold the plate off the seal surface and prevent an effective seal being formed when the semi-circular plates 16a, 16b are in their closed position. However, the runout groove 30 can be omitted in other circumstances, e.g. where a resilient rubber seal is bonded into the valve body 10.

FIG. 8c shows a cutaway view of the apparatus of FIG. 4 fully assembled. The cutaway runs along the longitudinal axes of the stop pin 20 and the hinge pin 17. It can be seen that the locking pins 22a, 22b pass through the through-holes 11a, 11b, the first and second apertures 21a, 21b of the stop pin 20 and the first and second apertures 18a, 18b of the hinge pin 17 to hold the stop pin 20 and the hinge pin 17 in their respective positions and prevent their movement.

When the valve body 10 is attached to a pipeline, the grub screws 23a, 23b are covered by the pipeline. This prevents disassembly of the check valve during use, and also acts as an anti-tamper device.

Alternative Arrangements

The invention is not limited to the specific embodiments disclosed above, and other possibilities will be apparent to those skilled in the art. For example, while the Figures show a dual plate check valve in which the blocking means is a pair of semi-circular plates, other suitable blocking means could also be used. For example, a single plate.

While the horizontal slots L have been described as being formed by milling in the example above, these slots could also be turned, or they could be formed using an investment casting process. While the through-holes 11a, 11 b have been described as being drilled into the bosses B in the example above, they could also by formed by broaching, water jet or plasma cutter. While the specific embodiment of the Figures discloses a pair of diametrically opposed horizontal slots L, the invention would also work with only a single horizontal slot.

1. A check valve comprising:
a valve body having a central bore;
a hinge pin;
a blocking means pivotably attached to the hinge pin and moveable between a first position in which the blocking means blocks the central bore and a second position in which the blocking means does not block the central bore; and
a biasing means arranged to bias the blocking means into the first position,
wherein the valve body comprises at least one boss projecting from an inner wall of the valve body into the central bore,
and wherein said boss provides an anchoring point at which the hinge pin is secured to the valve body.

2. A check valve according to claim 1, wherein the valve body comprises a pair of bosses located at diametrically opposed positions on the inner wall of the valve body, each boss providing anchoring points at which a respective end of the hinge pin is secured to the valve body.

3. A check valve according to claim 1, wherein the valve body comprises a horizontal slot extending along the central bore, along which the hinge pin may be inserted into the valve body.

4. A check valve according to claim 1, wherein the, or each, anchoring point comprises a through-hole extending through the, or each, boss, through which a retaining means may be passed to secure the hinge pin to the valve body.

5. A check valve according to claim 4, wherein the retaining means comprises a locking pin.

6. A check valve according to claim 1, wherein the blocking means comprises a pair of semi-circular plate members attached to the hinge pin.

7. A check valve according to claim 6, further comprising a stop pin positioned within the central bore to prevent the pair of semi-circular plate members from contacting one another.

8. A check valve according to claim 7, wherein the stop pin is secured to the valve body at the, or each, anchoring point.

9. A check valve according to claim 1, wherein the biasing means comprises a coil spring.

10. A method of assembling a check valve, the method comprising the steps of:
providing a valve body having a central bore, wherein the valve body comprises at least one boss projecting from an inner wall of the valve body into the central bore, said boss comprising an anchoring point;
providing a sub-assembly comprising a hinge pin, a blocking means pivotably attached to the hinge pin and moveable between a first position and a second position, and a biasing means arranged to bias the blocking means into the first position;
inserting the sub-assembly into the valve body;
rotating the sub-assembly until the hinge pin contacts the anchoring point; and
securing the hinge pin to the anchoring point,
wherein, following insertion of the sub-assembly into the valve body, the blocking means blocks the central bore in its first position and does not block the central bore in its second position.

11. A method according to claim 10, wherein the valve body comprises a pair of bosses located at diametrically opposed positions on the inner wall of the valve body, each boss providing anchoring points at which a respective end of the hinge pin may be secured to the valve body.

12. A method according to claim 10, wherein the valve body comprises a horizontal slot extending along the central bore, along which the hinge pin may be inserted into the valve body during the step of inserting the sub-assembly into the valve body.

13. A method according to claim 10, wherein the, or each, anchoring point comprises a through-hole extending through the, or each, boss, through which a retaining means may be passed to secure the hinge pin to the valve body.

14. A method according to claim 13, wherein the retaining means comprises a locking pin.

15. A method according to claim 10, wherein the blocking means comprises a pair of semi-circular plate members attached to the hinge pin.

16. A method according to claim 15, further comprising the step of positioning a stop pin within the central bore to prevent the pair of semi-circular plate members from contacting one another.

17. A method according to claim 16, wherein the stop pin is secured to the valve body at the, or each, anchoring point.

18. A method according to claim 10, wherein the biasing means comprises a coil spring.

19. A kit of parts for assembly into a check valve, the kit of parts comprising:
a valve body having a central bore, wherein the valve body comprises at least one boss projecting from an inner wall of the valve body into the central bore, said boss comprising an anchoring point;
a sub-assembly for insertion into the valve body, the sub-assembly comprising:
a hinge pin;
a blocking means pivotably attached to the hinge pin and moveable between a first position and a second position; and
a biasing means arranged to bias the blocking means into the first position, wherein, following insertion of the sub-assembly into the valve body, the blocking means blocks the central bore in its first position and does not block the central bore in its second position; and
means to secure the hinge pin to the valve body at the anchoring point.

20. A kit of parts according to claim 19, wherein the valve body comprises a pair of bosses located at diametrically opposed positions on the inner wall of the valve body, each boss providing anchoring points at which a respective end of the hinge pin is secured to the valve body.

21. A kit of parts according to claim 19, wherein the valve body comprises a horizontal slot extending along the central bore, along which the hinge pin may be inserted into the valve body.

22. A kit of parts according to claim 19, wherein the, or each, anchoring point comprises a through-hole extending through the, or each, boss, through which a retaining means may be passed to secure the hinge pin to the valve body.

23. A kit of parts according to claim 22, wherein the retaining means comprises a locking pin.

24. A kit of parts according to claim 19, wherein the blocking means comprises a pair of semi-circular plate members attached to the hinge pin.

25. A kit of parts according to claim 24, further comprising a stop pin positioned within the central bore to prevent the pair of semi-circular plate members from contacting one another.

26. A kit of parts according to claim 25, wherein the stop pin is secured to the valve body at the, or each, anchoring point.

27. A kit of parts according to claim 19, wherein the biasing means comprises a coil spring.
